(19) United States
(12) Patent Application Publication
(10) Pub. No.: US 2008/0097769 A1
(43) Pub. Date: Apr. 24, 2008

(54) SYSTEMS AND METHODS FOR PROVIDING CUSTOMER FEEDBACK

(76) Inventors: Brian W. Galvin, Warwick, RI (US); Marshall S. Votta, Greenville, RI (US)

Correspondence Address: STRATEGIC PATENTS P.C.., C/O PORTFOLIOIP, P.O. BOX 52050, MINNEAPOLIS, MN, 55402, US

(21) Appl. No.: 11/551,586

(22) Filed: Oct. 20, 2006

(51) Int. Cl. G06Q 10/00; G06Q 30/00

(52) U.S. Cl. 705/1

(57) ABSTRACT

Methods and systems of customer feedback include collecting customer feedback while the customer is physically located in a retail environment, transmitting the customer feedback through a wireless communication facility to a data processing facility, wherein the data processing facility automatically compares the customer feedback to at least one threshold value in accordance to a business rule to determine an alert action, and communicating a message to an employee of an enterprise associated with the retail environment. Customer feedback is also collected by a payment transaction facility including a touch screen display adapted to present transaction information and receive a signature. A customer query is presented on the touch screen display along with selectable answers to collect customer feedback.

### RELATED APPLICATIONS

This application claims the benefit of U.S. App. No. 60/128,701 filed on Oct. 20, 2005, the entire content of which is incorporated herein by reference.

### BACKGROUND

1. Field

The invention relates to systems and methods adapted for providing customer feedback, and more specifically, embodiments relate to methods and systems of providing customer feedback to an enterprise at a time of transaction and/or at a point of sale.

2. Description of the Related Art

Customer feedback may be provided to an enterprise for the purpose of improving services, food, entertainment, products, or other product or service the enterprise may provide. The enterprises may provide their customers with surveys as a paper handout after the transaction is complete, for example. These paper handouts may need to be filled out and mailed by the customer or dropped in a drop box. The enterprises may also provide a customer ID number and instruct the customer to access a web site for a survey of products and services. Another method for enterprise feedback is for the enterprise to contract with a survey company to poll customers for them, either in person, by phone, or by mail. These survey methods are sometimes accompanied with incentives to try to get customers to fill out the surveys.

Taking surveys may provide feedback to the enterprise but places a burden on the customer to either fill in the survey on paper or web connection on their own time at a location away from the enterprise. In addition, it is very difficult for an organization to appear responsive to the feedback due to the long process involved.

With the present systems, a store owner/manager may read complaints in the occasional customer comment card or letter to the manager, or may hear about it during the rare in-store summons (if a manager happens to be on site) or subsequent irate phone call. Worse, the customer that takes the time to complain may be the rare one; most customers who have a bad experience may simply choose never to return to that establishment. Information about a business not running well typically comes much too late. By the time a manager is made aware of such customer service problems, hours, days, or weeks may have passed, and the offending circumstances may have resulted in the loss of valuable patrons and the revenue they bring.

A need exists for an improved customer feedback system that allows an enterprise to respond to customer service issues in a more appropriate fashion.

### SUMMARY

Aspects of the present invention relate to obtaining customer feedback in a venue (e.g. a store, restaurant, retail establishment, wholesale establishment, or other establishment where it may be valuable or desirable to obtain customer feedback) while the customer is proximate to the venue and then transmitting the customer feedback to venue managers in time to service the customer based on the customer feedback. In embodiments, the customer feedback is gathered and transmitted to management in real-time or quasi-real-time. The collection and transmission of real-time customer feedback allows management to intervene with a provided service when necessary. For example, a restaurant may provide tabletop customer feedback stations so customers can push a button or otherwise interact with the device to provide feedback. The information may be recorded and then communicated to a network system (e.g. through a WiFi hot spot, cell phone network, pager network, or the like) such that the information is delivered to the appropriate people managing the restaurant. A store manager may, for example, receive customer feedback indicating that a customer is not satisfied. Since the customer is still in the store when the feedback is received, the manager can intervene to remedy the situation by approaching the customer directly or by addressing (e.g. correcting) a service or product. In embodiments, the systems and methods may involve comparing the feedback to a standard or threshold value (e.g. is the rating good, bed, terrible) and information relating to the compared feedback may be sent to various members within the restaurant's organization depending on the comparison (e.g. terrible ratings may initiate alerts to management).

In embodiments, a feedback collection system may be provided and the feedback collection system may be a tabletop, wall mount, floor mount, or otherwise mounted device. It may be placed at or near the customer while the customer is at the venue so the customer can interact with the system during a visit, upon checkout or at some other point during the customer's interaction. The feedback may then be transmitted to venue personnel through a network to a hand held, desktop, or other user interface facility.

A method and system of customer feedback may be a real-time or quasi-real-time customer service for a single and/or a multi-location enterprise to allow customers to provide feedback onsite at a point of transaction or a point of sale. The point of transaction or the point of sale may be at the register of a retail or service enterprise such as McDonald's, Starbucks, KFC, Gap, Old Navy, Abercrombie, Bank of America, Ritz Carlton, Mobil Gas Station, Southwest Airlines, Enterprise Rent-a-Car, U.S. Post Office, for example. The feedback may also be used in non-traditional point of sale enterprises such as restaurants, hotels, and automotive dealerships, for example.

The customer may be able to provide feedback using a device at the point of sale; the device may allow the customer to provide a quick rating of the enterprise service or product. The device may display a message asking the customer a question; the customer may provide a rating using one of a plurality of rating inputs. The device may be in a location in relation to the point of sale, point of service, or other point of customer interaction. In embodiments, the location of the feedback collection device may prohibit or inhibit the employee at the point of sale from witnessing or influencing the rating to the question. The rating may be a number rating, a star rating, a letter rating, or other rating indicator that may be input in relation to the question. The customer may be able to very quickly provide a rating in response to the question. In embodiments, the questions may be changed randomly, after every new customer, daily, weekly, monthly, or at a period defined by the enterprise.

Enterprises that do not have an ending register for checkout to place the feedback device may have the device at locations within the enterprise. A hotel may have the feedback as part of a quick check out on the hotel TV, using the remote control as part of the user interface, or an automobile dealership may have a plurality of devices in different departments (e.g. service or sales).

Once the customer has provided feedback to the feedback device the information may be provided to a person in a management position (e.g. department manager, store manager, owner) to determine if an action is needed. In embodiments, the feedback is provided in real time, quasi real time or otherwise. The enterprise may define the rating threshold at which a manager may be notified (e.g. notified of low ratings or high ratings). If a rating is received that meets a notification criteria (e.g. the rating is below a low threshold), the manager may receive a message such as a phone call, SMS message, email, VoIP, RSS feed, web page alert, fax, pager notification or other such message. The manager may be able to take an action to resolve the customer's low rating of the service or the product while the customer is in the enterprise.

In embodiments, the enterprise may establish notification rules for when the management position may be notified of a customer rating (e.g. a low rating, or a high rating). The management position may request notification based on a single rating, an average rating over a set period of time, or other parameter. The customer rating may be combined with enterprise data and may be associated to an employee, a shift of employees, and/or a product. The feedback may be provided to a local management position or may be provided to a management position at a remote location. The feedback information may be used to rate an enterprise's employees, services, or products.

While certain embodiments refer to discrete answers to questions, it should be understood that the customer feedback may be answers to open ended questions, discrete in nature, or other forms of feedback. In embodiments, the feedback may be solicited without the need for a question. For example, an alphanumeric key pad may be provided and a customer may just provide open ended feedback to be transmitted. The location at which the customer feedback collection facility is placed is generally referred to herein as a venue, store, enterprise or similar terminology. These terms of location are meant to provide illustrative examples and are not meant to restrict the invention, unless specifically indicated.

In an aspect of the invention, methods and systems may include providing an independent input collection device, displaying a query on a display facility of the input collection device, receiving a response to the query using an input facility of the input collection device, and providing for a secure entry of the response to the query. In the methods and systems, the display facility may be a CRT, plasma display, LCD display, LED display, or other such facility. The input facility may be a CRT, plasma display, LCD display, LED display, electronic button, mechanical button or other such facility. In the methods and systems, the secure input may allow for a customer to input responses without others seeing the responses. The input facility may be within an enclosure.

In another aspect of the invention, methods and systems may include providing an input collection device integrated into a second input device, displaying a query on a display facility of the input collection device, receiving a response to the query using an input facility of the input collection device, and providing for a secure entry of the response to the query. The second input device may be one of a credit input device, an electronic code reader, a proximity-based input device, and a debit input device. In the methods and systems, the display facility may a CRT, plasma display, LCD display, LED display or other such facility. The input facility may a CRT, plasma display, LCD display, LED display, electronic button, mechanical button or other such facility. In the methods and systems, the secure input may allow for a customer to input responses without others seeing the responses. The input facility may be within an enclosure.

In another aspect of the invention, methods and systems of notification may include recording an input response to a query, providing a predetermined set of input response rating threshold values, comparing the input response to the threshold values, selecting a notification individual based on the comparison, and notifying the selected individual of the recorded input response. In the methods and systems, the set of threshold values may be for at least one notification individual, or at least one notification individual has at least one threshold value. In the methods and systems at least one notification is transmitted to at least one notification individual. However, a notification individual may receive more than one notification.

In another aspect of the invention, methods and systems of notification may include recording an input response to a query, comparing the input response to a predetermined set of threshold values, determining a notification message based on the comparison, and transmitting the notification message electronically to a notification individual. The notification message may be transmitted when the notification message is determined. The electronic transmission of the notification message may be by a pager, an email, an SMS message, VoIP, a phone, a cell phone, an RSS feed, a web page alert, a fax or other such facility.

In another aspect of the invention, methods and systems of distributed query collection may include distributing more than one collection device within a location, providing a plurality of query response levels at each of the distributed collection devices, receiving responses from any of the distributed collection devices, and notifying a notification individual of responses entered into any of the distributed collection devices. The more than one response levels may be for at least one type of service. The notification individual notified may be responsible for the type of service receiving the query response. In the methods and systems, responses may be entered into any of the distributed collection devices.

In another aspect of the invention, methods and systems of response collection infrastructure may include collecting responses from at least one query collection device, storing responses in a data structure associated with a network device, comparing the stored responses to a set of stored threshold levels, and distributing messages to at least one notification individual device based on the comparison. The data structure may be a table, a database, a relational database, text file, document, an XML document or other such facility. The storage device may be a hard drive, holographic storage device, a flash drive, a CD drive, a DVD drive, RAM, a zip drive, a tape drive or other such facility. The at least one notification individual device may be a one of a phone, a cell phone, an SMS message, an email, an RSS feed, a web page alert, a fax, a pager or other such facility. The message may be transmitted to one of the notification individual devices.

In another aspect of the invention, methods and systems of query response aggregation may include gathering customer query responses on a storage device, aggregating the query responses relative to a set of stored threshold values, and reporting the aggregated responses by at least one enterprise human resource. The enterprise human resource may be an employee.

In another aspect of the invention, methods and systems may include receiving a customer query response within an enterprise, comparing the customer query response to a set of threshold values, and notifying a notification individual of a customer response in conflict with a threshold value while the customer is within the enterprise. The set threshold values may be unique for each notification individual. There may be a threshold value for at least one notification individual.

In another aspect of the invention, methods and systems may involve gathering customer query responses on a storage device, aggregating the query responses relative to a set of stored threshold values, and reporting the aggregated responses

In another aspect of the invention, methods and systems of query response access may include gathering customer query responses on a storage device, providing the gathered customer query responses as a web service, accessing the gathered customer query responses from a web connected device, and performing aggregation of the gathered customer query responses through the web connection.

In another aspect of the invention, methods and systems of query response, comprising, locating an input collection device outside of an enterprise, receiving a customer query response at the enterprise outside location, comparing the customer query response to a set of threshold values, and notifying a notification individual of a customer response in conflict with a threshold value while the customer is located at the enterprise outside location. The enterprise may provide services received at the outside location.

In an aspect of the invention, a method may include collecting customer feedback while the customer is physically located in a retail environment, transmitting the customer feedback through a wireless communication facility to a data processing facility, wherein the data processing facility automatically compares the customer feedback to at least one threshold value in accordance to a business rule to determine an alert action, and communicating a message to an employee of an enterprise associated with the retail environment.

In the method, the step of collecting the customer feedback may also include collecting the customer feedback through a tabletop collection facility. The tabletop collection facility may include an advertisement facility adapted to display an advertisement. The wireless communication facility may include a cell phone transmission facility, a pager transmission facility, a WiFi transmission facility, or a Bluetooth transmission facility.

In the method, the message may be an instant message, an email, an SMS, web page.

In the method, the step of communicating the message to an employee may involve communicating the message to a plurality of employees. At least one of the plurality of employees may be a manager or a district manager. The step of communicating the message to an employee comprises communicating a plurality of messages to a plurality of employees. Also the plurality of messages may be different.

In the method, the retail environment may be a book store a grocery store, a hardware store, an electronics store, or a software store.

In another aspect of the invention, a method of collecting customer feedback may include providing a payment transaction facility, wherein the payment transaction facility may include a touch screen display adapted to present transaction information and receive a signature, presenting a customer query on the touch screen display, and presenting selectable answers on the touch screen display in an attempt to collect customer feedback.

In the method the payment transaction facility may be adapted to accept credit cards, debit cards, smart cards, RFID device, or RFID transaction cards.

The selectable answers may be selectable by touching the touch screen.

In the method, the customer feedback may be transmitted to an employee of a retail enterprise associated with the payment transaction facility. The transmission may be made substantially in real time. The customer feedback may be compared against a threshold value in accordance to a business rule.

In another aspect of the invention, a system may include an input collection facility physically located in a retail environment for collecting customer feedback, a wireless communication facility for transmitting the customer feedback to a data processing facility, wherein the data processing facility automatically compares the customer feedback to at least one threshold value in accordance to a business rule to determine an alert action, and an enterprise communication facility for communicating a message to an employee of an enterprise associated with the retail environment.

The input collection facility may be a tabletop collection facility. Also, the tabletop collection facility may include an advertisement facility adapted to display an advertisement.

In the system, the wireless communication facility may include a cell phone transmission facility, a pager transmission facility, a WiFi transmission facility, or a Bluetooth transmission facility.

In the system, the message may be an instant message, an email, or an SMS.

In the system, communicating the message to an employee may involve communicating the message to a plurality of employees. At least one of the plurality of employees may be a manager. Also, at least one of the plurality of employees may be a district manager.

Communicating the message to an employee may include communicating a plurality of messages to a plurality of employees. However, each of the plurality of messages may be different.

In the system, the retail environment may be a book store, a grocery store, a hardware store, an electronics store, or a software store.

In another aspect of the invention, a system of collecting customer feedback may include a payment transaction facility, wherein the payment transaction facility may include a touch screen display adapted to present transaction information and receive a signature, a customer query presented on the touch screen display, and selectable answers presented on the touch screen display in an attempt to collect customer feedback.

In the system, the payment transaction facility may be adapted to accept credit cards, debit cards, smart cards, or RFID transaction cards.

The selectable answers may be selectable by touching the touch screen.

In the system, the customer feedback may be transmitted to an employee of a retail enterprise associated with the payment transaction facility. The transmission may be made substantially in real time.

In the system, the customer feedback may be compared against a threshold value in accordance to a business rule.

These and other systems, methods, objects, features, and advantages of the present invention will be apparent to those skilled in the art from the following detailed description of the preferred embodiment and the drawings. All documents mentioned herein are hereby incorporated in their entirety by reference.

### BRIEF DESCRIPTION OF THE FIGURES

The invention and the following detailed description of certain embodiments thereof may be understood by reference to the following figures:

FIG. 1 depicts an embodiment of a feedback device for customer input.

FIG. 2 depicts a high level flow chart of the notification method based on the customer rating.

FIG. 3 shows a high level flow chart of the applying customer feedback in relation to business metrics.

### DETAILED DESCRIPTION

The invention may be better understood with a detailed description of the figures. A customer feedback method and system may include a device for capturing customer ratings of services or products with the ratings being transmitted to one of an enterprise's management positions. The feedback device may be adapted to receive the customer rating input and a method may be used to direct the data to the management position and/or added to the enterprises databases to be associated with a service or product.

Various embodiments of the invention are presented as examples only and are not intended to limit or restrict the scope of the invention.

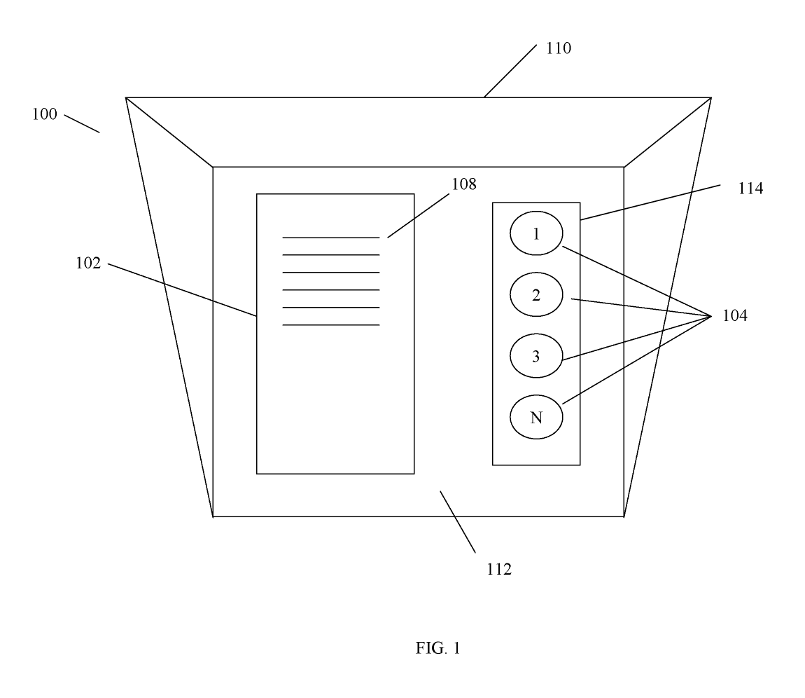

Referring to FIG. 1, an embodiment of a feedback device 100 is shown. The feedback device 100 may contain a message area 102 and inputs 104 for the customer to provide the rating of the enterprise services or products. The feedback device 100 may be a self contained device or may be a device that may be incorporated into another device such as a cash register or a credit/debit card reader. The feedback device 100 may be situated to allow the customer privacy in selecting a rating answer to the message 108 or question that may be displayed in the message area 102. The feedback device may be so arranged as to prevent an employee from seeing the customer provide the rating into the feedback device 100.

In embodiments, the feedback device 100 may be constructed with a face 112 (e.g. made or metal or plastic) that may include an enclosure 110 to further hide the customers input. The feedback device 100 may have a separate message area 102 for displaying messages 108 with questions for the customer. The feedback device may also contain a plurality of inputs 104, such as mechanical, electrical, electromechanical inputs (e.g. digital pen) or may be virtual inputs on an electronic display (e.g. interacted through mouse, touch screen, keyboard and the like).

The message area 102 may present questions to the customer that may vary based on the information the enterprise may want to capture. The message 108 may be a generic question such as “How do you rate the service?” to more detailed questions to a certain type of service or product. The message area 102 may be a display screen such as a CRT, plasma display, LCD display, or LED display and therefore may allow the easy changing of the message 108 in the message area 102 by use of a connected computer device. The message area 102 may also be a non-electronic hard copy message 108 that may be changed manually for different messages, for example.

The messages 108 in the message area 102 may be changed at a frequency determined by the enterprise or a device may be made that does not facilitate changing of the messages. The enterprise may predetermine a plurality of messages 108 for which the customer response is important to their business strategy. These predetermined messages 108 may not be change, be randomly changed, changed after each customer, changed daily, changed weekly, changed monthly, or changed at any frequency the enterprise determines appropriate. A computer device may be used to determine the order the messages 108 that may be displayed or the enterprise may choose the order the messages 108 are displayed. There may only be one message 108 that is continually displayed to the customer.

The inputs 104 may provide the customer with an input to supply answers in response to the message 108 displayed in the message area 102. In embodiments, the inputs 104 may be contain a preset number of inputs available for customer input. The enterprise may be able to assign the rating meaning to each of the inputs 104, for example, ranging from excellent to poor. The assigned rating may be labeled on the inputs 104 to make the meaning of the inputs plain to the customer, for example.

The inputs 104 may be on a touch sensitive display 114 such as a CRT, plasma display, LCD display, electronic paper, or LED display that may allow for virtual inputs 104 to be displayed. Using this input display 114, the enterprise may be able to vary the number and importance of the inputs 104 depending on the displayed message 108 in the message area 102. The display and customer responses of the inputs 104 may be controlled by a computer device.

In embodiments, the feedback device face 112 may be an electronic touch sensitive display such as a CRT, plasma display, LCD display, or LED display. The electronic display face 112 may be able to display the messages 108 in the message area 102 and display virtual inputs 104. In this embodiment a computer device may be adapted to control the layout and visual affects of the feedback device face 112 and may be able to display messages 108 and the response inputs 104 on the electronic display.

The feedback device 100 may also be displayed on a typical credit/debit input device that may be available at the point of sale. Before, after or instead of the credit/debit information, the feedback message 108 may be displayed along with inputs 104 for the customer response.

The feedback device 100 may be placed at a point of sale but may also be placed in a plurality of other locations that an enterprise may wish to gather customer input. For example, a plurality of feedback devices 100 may be placed in an automobile dealership where a customer may be able to provide feedback on a salesperson, sales department, billing, or service department. The feedback device 100 may also be made as a weather tight device that may allow the feedback device 100 to be placed outdoors. For example, an outdoors feedback device 100 may be able to receive customer feed back a fast food drive through for customers to rate the drive through service. The device may be made as a device to stand in the middle of a table (e.g. a dining table) and the device may contain a wireless transmission facility designed to communicate the customer inputs to a computer assessment system on the premises or remote from the premises. The wireless transmission facility may also be adapted to receive new questions or the like to update the tabletop feedback device.

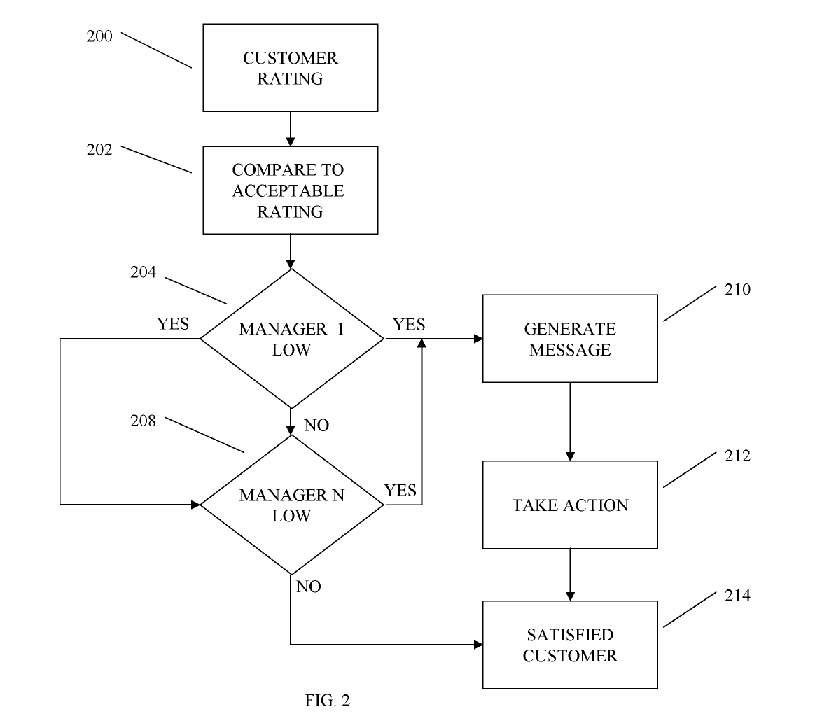

Referring to FIG. 2, a high level flow chart of the notification method based on the customer rating is shown. Using the feedback device 100 discussed in connection with FIG. 1, the customer may enter a rating 200 related to a service or product of an enterprise. The customer rating response may be in the form of a discrete rating (e.g. range from satisfied to dissatisfied) continuous style variable feedback (e.g. 3.2 out of 5), it may contain text (e.g. written feedback), images (e.g. ‘smiley faces,’ drawings, or other images depicting impressions) and/or multimedia (e.g. a voice message providing feedback, a picture or video depicting relevant information). The feedback device may receive the customer rating 200 and compare the rating 202 to threshold values that the enterprise may have set. The threshold values may be stored in a table, database, XML document, or other data storage file. The customer's rating 200 may be accumulated and stored on the feedback device 100 using a hard drive, holographic storage device, flash drive, CD, DVD, or other storage medium. The customer rating 200 may be passed directly to an enterprise computer device such as a computer, laptop computer, PDA, server, or other computer device for storage and aggregation. The communication between the feedback device and the receiving computer system may be wired or wireless, for example. In embodiments, the feedback is not necessarily compared to threshold values and the feedback may simply be passed on. For example, a manager of a restaurant may want to receive all feedback generated during the day. In addition, certain feedback may be passed on, such as text, images, multi-media information, that is not readily comparable to a threshold. Information that is not readily comparable to a standard in an automated way may be passed through a manual review process, for example.

The enterprise may determine the acceptable rating 202 value ranges to which the customer ratings 200 are compared. The enterprise may set the acceptable rating 202 settings at which point a message may be sent to alert an enterprise manager of a low customer rating. The settings may be applied to an instantaneous customer rating 200, to an average customer rating 200 aggregated over a period of time, or other form of rating calculation.

The enterprise manager may be any of the management chain for the enterprise such as a department manager, enterprise manager, or owner. The enterprise manager may be located on the same site as the feedback device 100 or the enterprise manager may be remotely located.

After the customer rating 200 is compared to the acceptable or threshold rating 202 a decision may be required to determine if the customer rating 200 is below, above or meeting the acceptable rating 202 value. The decisions may be made at different manager levels with each manager receiving a notification at predetermined customer rating 200 levels. In an embodiment, a first tier manager may assume responsibility to resolve customer ratings 200 at a first value while a second tier manager assumes the correction responsibility at a second customer rating. The feedback system may provide message reporting to a plurality of management tiers that may have the same or unique notification levels. For example, manager one (204) may receive customer rating 200 notification for any feedback less than a rating of three where manager two (208) may only get a notification message if the average of customer ratings are less than three. In this manner, the compared customer rating 202 may pass through a plurality of enterprise managers to determine if a notification is necessary at each manager level.

At each decision point on the process flow, it may be determined if the rating is above, below or meeting the threshold of the manager. If it is outside certain parameters (e.g. low as compared to the threshold), the feedback system may generate a message 210. The message may be generated 210 and communicated to any of the managers for which the response meets notification criteria for the manager. It may be that several managers get a generated message 210 for the same customer rating 200 (e.g. several managers notified of a great performance rating or a poor performance rating). Each manager in the management chain may have a unique message 210 to alert the manager of a certain customer rating.

A customer rating 200 may be below the manager one (204) threshold and therefore generate a message 210 to manager one, for example. If the customer rating 200 is in a range for which the manager one (204) requires notification, a decision may be made as to whether the customer rating should also be passed to manager two (208). Certain situations may generate a message 210 to both manager one (204) and manager two (208).

By way of another example, a customer rating 200 may be above the manager one (204) low threshold and therefore not generate a message 210. A second decision may be made to determine if the customer rating 200 should be passed to manager two (208) by comparing the rating to manager two's threshold. The customer rating 200 may be below manager two's (208) low threshold and therefore a message 210 may be generated and communicated to manager two (208). In this manner, one manager may receive a generated message 210 but another manager may not receive a generated message 210. In an embodiment, a lower manager may receive a copy of a message 210 communicated to a higher manager, therefore informing him when his boss has received a customer message 210.

The generated messaged 210 in response to a customer rating 200 may be sent to a phone, cell phone, PDA, computer monitor, electronic paper, by SMS message, email, RSS feed, web page alert, fax, pager and/or other communication facility. Each manager in the decision chain may receive their own messages and the messages may vary based on the value of the customer rating. For example, a message 210 that is just below the acceptable threshold may only require an upper manager to monitor the feedback system for any additional low customer ratings 200. A very low customer rating 200 may generate a message 210 for the upper manager to try to locate the customer to determine if the manager can resolve the customer's dissatisfaction. Generated messages 210 may be transmitted to managers on the enterprise site or may send generated messages 210 to managers to remote sites.

After a manager receives a feedback message 210, the manager may determine an action 212 that needs to be taken. One advantage of the feedback system is that the manager may receive the customer rating 200 within moments of the customer providing the feedback. With quick communication of the feedback, the manager may be able to talk to the customer while the customer is still in the enterprise. The rapid response by a manager to a customer low rating may turn a bad customer experience to a good experience. Different manager levels may take different levels of action 212. A first line department manager may be able to find and help resolve a customer problem in the enterprise, while an upper manager may monitor the customer ratings 200 and create new strategies to resolve repeated low customer ratings 200.

The action step 212 may also allow a manager to aggregate customer rating 200 information over time and make management decisions based on the information. For example, a manager's yearly review may include the average, high and low customer ratings 200 in the mangers area of responsibility. Based on the aggregated information, the manager may be able to determine if the low customer ratings are from one employee, shift of employees, a certain time frame (e.g. lunch or dinner breaks), or with a certain product or service.

An indirect action step 212 may be that the employees may know that the customers may be able to rate their service instantly and the manager may be monitoring the customer ratings 200 on a constant basis. Employees that know that the manager is able to monitor their service ratings instantaneously may provide the best available service to customers.

A satisfied customer 214 may be a customer that entered a customer rating 200 that was higher than all of the manager's thresholds and therefore the customer rating 200 did not generate any messages 210, for example. Another way for an enterprise to have a satisfied customer 214 is for the low customer rating 200 to be resolved quickly by a manager taking action 212 in real time. A customer may be upset at the point of sale either by the service received or by a product and a manager may be able to resolve the issue before the customer leaves the enterprise. Customers may be satisfied 214 when they are approached by a manager without having to request a manager from an employee. A customer that knows that the rating input provided to the feed back device 100 may be an incentive for employees to provide the best available service.

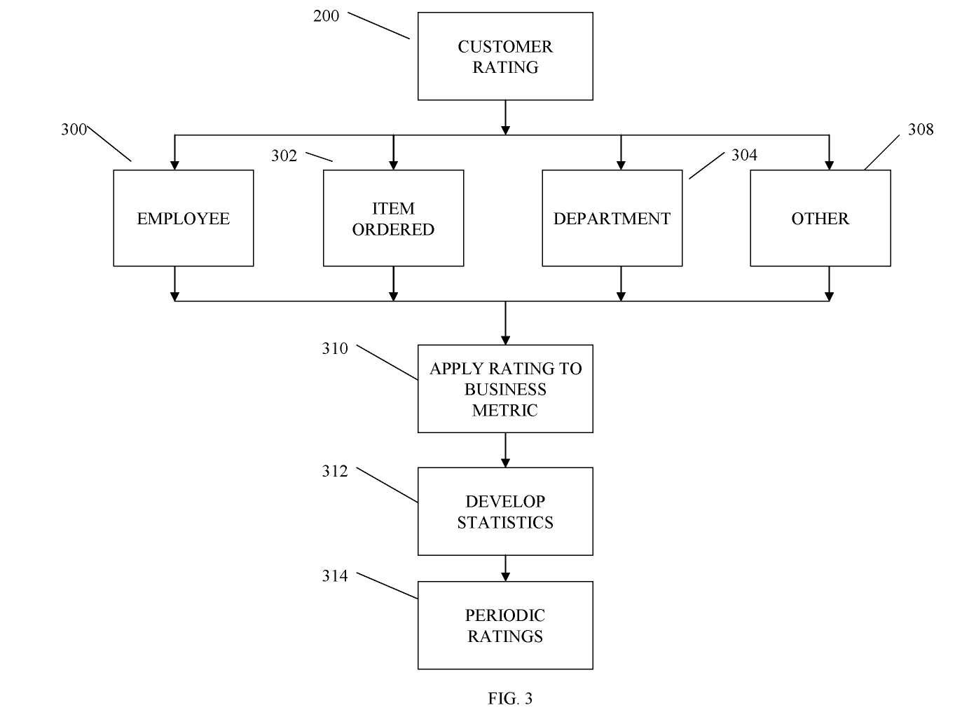

Referring to FIG. 3, a high level flow chart of applying customer feedback in relation to business areas is shown. The information collected by the feedback system may be combined with enterprise business data to allow the enterprise to correlate business data with customer ratings. The customer rating 200 data may be aggregated and compared to business data of the same period. The customer rating 200 may be combined with employee data 300, items ordered 302, department efficiency 304, or other 308 business metric. The customer rating 200 levels may be compared to which employee(s) are on duty, when certain type of items ordered, how efficiently a department is functioning with amount of sales per employee.

The customer ratings 200 may be applied to business metrics 310 to create a customer to business rating in relation to customer ratings. These business ratings to customer ratings may allow an enterprise to compare different employees 300, items 302, or departments 304 metrics and develop statistics 312 for the different aspects of the enterprise to improve the enterprise performance in the affected areas.

The collected feedback data may be stored as part of the enterprises data structure or may be stored as its own data structure to be related to the enterprise data structure. The collected feedback data may be stored on the feedback device 100, enterprise computer device such as a computer, laptop computer, tablet computer, PDA, or other computer device. The process of relating of the collected feedback data to the enterprise business data may allow the enterprise to create correlations between the enterprise business data metrics and the responses by customers. The correlations may be developed based on date, time, shift, employee, manager, store, items sold, or other metric the enterprise tracks.

The collected feedback data may also be accessible through a web accessible connection allowing remotely located enterprise managers access to the customer ratings 200. The collected feedback data may be directly transmitted from the feedback device 100 using wired or wireless communication devices. In embodiments, the feedback may be transmitted through an enterprise computer device. A World Wide Web customer response data may be aggregated and presented in a similar fashion as may be provided on the enterprise data structure.

In embodiments, a customer feedback system is supported through a network (e.g. Internet) infrastructure. For example, the feedback device adapted to receive customer feedback may transmit the information to a server application, either directly or indirectly (e.g. through a wireless service provider such as Verizon, Sprint, AT&T and the like). The server application may be adapted the retransmit the information to managers and the like, once the information is received by the server application. The information may also be stored in a web accessible repository for later retrieval or manipulation.

The enterprise may be able to apply the metrics 310 and statistics 312 to develop periodic ratings 314 for employees, items, departments, or other aspects of the enterprise. The periodic ratings may be provided to managers to develop strategies to improve performances of an employee, item, or department. The periodic ratings may also become part of the periodic rating system of a manager or employee.

The elements depicted in flow charts and block diagrams throughout the figures imply logical boundaries between the elements. However, according to software or hardware engineering practices, the depicted elements and the functions thereof may be implemented as parts of a monolithic software structure, as standalone software modules, or as modules that employ external routines, code, services, and so forth, or any combination of these, and all such implementations are within the scope of the present disclosure. Thus, while the foregoing drawings and description set forth functional aspects of the disclosed systems, no particular arrangement of software for implementing these functional aspects should be inferred from these descriptions unless explicitly stated or otherwise clear from the context.

Similarly, it will be appreciated that the various steps identified and described above may be varied, and that the order of steps may be adapted to particular applications of the techniques disclosed herein. All such variations and modifications are intended to fall within the scope of this disclosure. As such, the depiction and/or description of an order for various steps should not be understood to require a particular order of execution for those steps, unless required by a particular application, or explicitly stated or otherwise clear from the context.

The methods or processes described above, and steps thereof, may be realized in hardware, software, or any combination of these suitable for a particular application. The hardware may include a general-purpose computer and/or dedicated computing device. The processes may be realized in one or more microprocessors, microcontrollers, embedded microcontrollers, programmable digital signal processors or other programmable device, along with internal and/or external memory. The processes may also, or instead, be embodied in an application specific integrated circuit, a programmable gate array, programmable array logic, or any other device or combination of devices that may be configured to process electronic signals. It will further be appreciated that one or more of the processes may be realized as computer executable code created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software.

Thus, in one aspect, each method described above and combinations thereof may be embodied in computer executable code that, when executing on one or more computing devices, performs the steps thereof. In another aspect, the methods may be embodied in systems that perform the steps thereof, and may be distributed across devices in a number of ways, or all of the functionality may be integrated into a dedicated, standalone device or other hardware. In another aspect, means for performing the steps associated with the processes described above may include any of the hardware and/or software described above. All such permutations and combinations are intended to fall within the scope of the present disclosure.

Various embodiments and aspects of the invention are presented as examples only and are not intended to limit or restrict the scope of the invention.

While the invention has been disclosed in connection with the preferred embodiments shown and described in detail, various modifications and improvements thereon will become readily apparent to those skilled in the art. Accordingly, the spirit and scope of the present invention is not to be limited by the foregoing examples, but is to be understood in the broadest sense allowable by law.

All documents referenced herein are hereby incorporated by reference.

1. A method, comprising:
collecting customer feedback while the customer is physically located in a retail environment;
transmitting the customer feedback through a wireless communication facility to a data processing facility, wherein the data processing facility automatically compares the customer feedback to at least one threshold value in accordance to a business rule to determine an alert action; and
communicating a message to an employee of an enterprise associated with the retail environment.

2. The method of claim 1, wherein the step of collecting the customer feedback further comprises collecting the customer feedback through a tabletop collection facility.

3. (canceled)

4. The method of claim 1, wherein the wireless communication facility includes a cell phone transmission facility.

5. The method of claim 1, wherein the wireless communication facility includes a pager transmission facility.

6. The method of claim 1, wherein the wireless communication facility includes a WiFi transmission facility.

7. The method of claim 1, wherein the wireless communication facility includes a Bluetooth transmission facility.

8. (canceled)

9. The method of claim 1, wherein the message is an email.

10. The method of claim 1, wherein the message is an SMS.

11. The method of claim 1, wherein the step of communicating the message to an employee involves communicating the message to a plurality of employees.

12. The method of claim 11, wherein at least one of the plurality of employees is a manager.

13. The method of claim 12, wherein at least one of the plurality of employees is a district manager.

14. The method of claim 1, wherein the step of communicating the message to an employee comprises communicating a plurality of messages to a plurality of employees.

15-20. (canceled)

21. A method of collecting customer feedback, comprising:
providing a payment transaction facility, wherein the payment transaction facility includes a touch screen display adapted to present transaction information and receive a signature;
presenting a customer query on the touch screen display; and
presenting selectable answers on the touch screen display in an attempt to collect customer feedback.

22. The method of claim 21, wherein the payment transaction facility is adapted to accept credit cards.

23. The method of claim 21, wherein the payment transaction facility is adapted to accept debit cards.

24. The method of claim 21, wherein the payment transaction facility is adapted to accept smart cards.

25. The method of claim 21, wherein the payment transaction facility is adapted to accept RFID transaction cards.

26. The method of claim 21, wherein the selectable answers are selectable by touching the touch screen.

27. The method of claim 21, wherein the customer feedback is transmitted to an employee of a retail enterprise associated with the payment transaction facility.

28. The method of claim 27, wherein the transmission is made substantially in real time.

29. The method of claim 27, wherein the customer feedback is compared against a threshold value in accordance to a business rule.

30. A system, comprising:
an input collection facility physically located in a retail environment for collecting customer feedback;
a wireless communication facility for transmitting the customer feedback to a data processing facility, wherein the data processing facility automatically compares the customer feedback to at least one threshold value in accordance to a business rule to determine an alert action; and
an enterprise communication facility for communicating a message to an employee of an enterprise associated with the retail environment.

31-49. (canceled)

50. A system of collecting customer feedback, comprising:
a payment transaction facility, wherein the payment transaction facility includes a touch screen display adapted to present transaction information and receive a signature;
a customer query presented on the touch screen display; and
selectable answers presented on the touch screen display in an attempt to collect customer feedback.

51-58. (canceled)
